(19) United States
(12) Patent Application Publication
(10) Pub. No.: US 2002/0095356 A1
(43) Pub. Date: Jul. 18, 2002

(54) Method and system for providing products in a network environment

(75) Inventors: Akihide Tonegawa, Yokohama (JP); Tetsuya Ushio, Kawasaki (JP)

Correspondence Address: Townsend and Townsend and Crew LLP, 8th floor, Two Embarcadero Center, San Francisco, CA, 94111, US

(73) Assignee: HITACHI, LTD., Tokyo (JP)

(21) Appl. No.: 09/963,931

(22) Filed: Sep. 25, 2001

(30) Foreign Application Priority Data
Jan. 18, 2001 (JP) 2001-010687

(51) Int. Cl. G06F 17/60

(52) U.S. Cl. 705/27

(57) ABSTRACT

Embodiments of the present invention are directed to providing, in a network environment, a one-stop location for product/combination options selected from products consisting of multiple elements, thus attracting the interest of users having varied needs. An information entry module receives user input information from a user relating to selection of a plurality of products. Each product has one or more associated net markets which are arranged into categories for each of the plurality of products. A route setting module sets up travel routes through the categories containing the net markets associated with the plurality of products which are received by the information entry module. Product information of the plurality of products from the net markets associated with the products is presented to the user, who can perform transactions with the net markets along the travel routes based on the product information.

### CROSS-REFERENCES TO RELATED APPLICATIONS

This application is related to and claims priority from Japanese Patent Application No. 2001-010687, filed Jan. 18, 2001, the disclosure of which is incorporated herein by reference.

### BACKGROUND OF THE INVENTION

The present invention relates to a cyber-mall system that can provide products (both goods and services) suited to user needs using multiple net markets (systems run by providers of products services, or the like, and intermediary systems for products, services, or the like).

A WWW (World Wide Web) server is a computer system that is equipped with functions for sending information. A WWW server stores information including contents that can be viewed from the Internet, such as electronic catalogs generated using HTML (Hyper Text Markup Language), documents and images and XML (eXtended Markup Language). In response to requests from client terminals, e.g., web browsers, this information is sent through a network such as the Internet.

A service site (product provider site) combines these types of information on a WWW server to form products, which are provided to the users. The users referred to here indicate both general consumers and corporate purchasing personnel.

Conventionally, when an Internet service site has been used to perform one-stop purchases (involving just one input operation to a particular site, a particular server, or the like) of services formed from multiple elements and combinations based on complex rules (hereinafter “configurations”), the options for component elements (types of elements and providers) have been limited.

For example, when a customer purchases a product at a service site, the service site may be bound to one distributor that provides shipping services. Even though there may be another distributor that can ship the product at lower cost and on the desired day, the user is not able to select the other distributor. Furthermore, if insurance for shipping the product is also to be purchased, the options will in essence be narrowed even further. In addition, the prices and shipping dates for these services can vary dynamically. It is difficult for one service site to manage the site so that multiple businesses can present prices and shipping dates dynamically, and this also narrows options.

As another example, a user may be planning to take a trip overseas and to stay in several cities. In this case, airline tickets, hotels, domestic transportation tickets, and the like, must be selected from a limited number of combinations even if a major travel service site is accessed. While an optimization engine can be used to search for combinations most suited to user needs, the available options are still ultimately limited and there may be other more desirable combinations elsewhere. In practice, products are often provided as packages (combination products). As in the previous case, the appeal for the user is reduced since prices are fixed even though discounts and the like exist elsewhere. As a result, developing this type of service site business is difficult since differentiation through the number of products handled and improved ease of use is difficult. This makes it difficult to develop an alluring business.

One leading-edge computer maker in the United States provides a service site where multiple configurations are offered over the Internet by collecting base systems from partner firms in real time. This system appears to offer the user one-stop purchase of products, but there may be other parts manufacturers that provide more cost-effective products. The options available from this system are based only on the products from the firms that have established partnerships with this computer maker. If one attempts to link base systems from firms, as needed in an on-demand manner to provide performance, implementation of dynamic system linking is difficult. Because this linking is difficult, attempting to implement similar services by using one server to collect from providers a vast amount of such widely variable data as shipping dates, prices, and specifications, creates difficulties in the efficient management of this information and the matching of this information with user needs. Furthermore, this does not solve the problem involving distribution described above.

In recent years, intermediary businesses (hereinafter “net markets”) have emerged that operate over a network and provide a place where any number of buyers and sellers can meet through auctions, negotiations, and searches based on registration data, thus allowing products to be bought and sold. These sites are equipped with systems to do business with any number of providers. However, these sites do not allow one-stop purchases of products that need configurations or services formed from multiple elements. In net market systems that provide search functions, business is conducted around a single set of fixed data in the form of an electronic catalog created using XML or the like. In order to provide products needing configurations or combination products that match users' varied needs, a vast number of electronic catalogs that can be combined must be prepared, which is not realistic. In a single auction or negotiation net market system, operations are limited to the combinations provided by the sellers themselves. As a result, a user would have to visit multiple net markets and perform extremely tedious studies of combinations.

An example of this type of net market is presented in the context of the travel situation described above. A user inputs a desired route and hotel grade. Since the travel agencies participating as sellers in the net market participate in bidding by combining elements managed in their own (the travel agencies') databases, it is still possible that a desirable combination will not be provided. This system is advantageous for the travel agency since business opportunities can be increased while the work involved stays the same, but it is possible that administration becomes more difficult with no added customer appeal. Thus, even if a net market business may be convenient for the user, convenience alone may not lead to business expansion.

With separate net markets, e.g., a hotel net market, an airline ticket net market, a domestic transportation net market, it is possible to combine transaction results and determine the optimum combination out of any number of possible combinations. However, inspecting these combinations involves a vast amount of work for the user and does not provide improved convenience.

Japanese laid-open patent publication number 11-249983 discloses a workflow/item management mechanism and method where a workflow mechanism is used to improve the efficiency of conventional mall browsing. In Japanese laid-open patent publication number 11-96099, a service providing system is described where one-stop product purchases are provided by storing user interests and history information. However, these technologies do not provide a way to manage the information interchange between net markets and user-requested shipping dates that would be required to provide combination products.

Accordingly, users purchasing products from the Internet face limitations in meeting personalized needs.

### BRIEF SUMMARY OF THE INVENTION

Embodiments of the present invention are directed to the providing, in a network environment such as the Internet, a one-stop location for product/combination options selected from products consisting of multiple elements, thus attracting the interest of users having varied needs.

According to specific embodiments, the present invention provides product combinations that meet user needs using a new method distinct from the one used in the net market model for allowing any number of transactions to be performed, where combinations and combination types are all prepared as data that assumes transactions will involve one fixed set of data.

In accordance with an aspect of the present invention, a system for providing products to a user in a network environment comprises an information entry module configured to receive user input information from a user relating to selection of a plurality of products. Each product has one or more associated net markets which are arranged into categories for each of the plurality of products. A route setting module is configured to set up travel routes through the categories containing the net markets associated with the plurality of products which are received by the information entry module. An information receiving module is configured to receive product information of the plurality of products from the net markets associated with the products along a travel route set up by the route setting module.

In some embodiments, a category association database stores rules for linking the net markets associated with the plurality of products. The route setting module sets up travel routes through the categories containing the net markets associated with the plurality of products according to the rules for linking the net markets stored in the category association database. This allows routes containing the required categories to be set up in a reliable manner. The information entry module presents to the user, products linked by the category association database according to the rules for linking the net markets associated with the plurality of products, in response to the user input information received from the user relating to the selection of the plurality of products. This allows easy entry of information about multiple products.

In some embodiments, the information receiving module receives, along the route set up by the route setting module, product information in each category for products that can be combined to form one or more sets of products, based on candidate product information received in a previous category along the route. This provides the user with product information meeting the user's needs not merely as multiple, individual products, but as multiple products in combination.

When the product information received by the information receiving module covers a plurality of sets of products supplied by the net markets, a prioritization module is configured to prioritize the sets of products according to an order of priority based on the user input information received from the user relating to the selection of the plurality of products. An output module is configured to output to the user the sets of products in the order of priority. This allows the user to select from multiple product sets based on priorities assigned by the system. A transaction module is configured to transact with the net markets along the travel routes.

In accordance with another aspect of the present invention, a method for providing products to a user in a network environment comprises receiving from a user entry of information relating to selection of a plurality of products. Each product has one or more associated net markets which are arranged into categories for each of the plurality of products. The method further comprises extracting from a net market management database, which contain net market information of net markets, the net markets associated with the plurality of products based on the information received from the user relating to selection of the plurality of products. One or more travel routes are set up through the categories containing the net markets associated with the plurality of products. Transactions with the net markets are performed along the one or more travel routes.

Another aspect of the present invention is directed to a memory for storing data for access by an application program being executed in a data processing system. The memory comprises a first data structure stored in the memory. The first data structure is used by the application program and comprises net market information of a plurality of net markets including net markets which are associated with a plurality of products selected in response to user input information provided by a user relating to selection of the plurality of products. A second data structure stored in the memory is used by the application program, and comprises rules for linking the net markets associated with the plurality of products selected in response to the user input information provided by the user relating to the selection of the plurality of products. The associated net markets are arranged into categories for each of the plurality of products. The rules for linking net markets are to be used for setting up net market travels routes through the categories.

In some embodiments, a third data structure stored in the memory is used by the application program, and comprises net market travel routes generated based on the rules for linking net markets, in response to the user input information provided by the user relating to the selection of the plurality of products.

### BRIEF DESCRIPTION OF THE DRAWINGS

FIG. 1 shows a data structure for a net market management table according to an embodiment of the present invention.

FIG. 2 shows a data structure for a route settings table according to an embodiment of the present invention.

FIG. 3 shows a data structure for a category association table according to an embodiment of the present invention.

FIG. 4 shows a structure for a category check database according to an embodiment of the present invention.

FIG. 5 is a flowchart illustrating the operations performed from the time a user accesses a configuration portal site and enters the needed specifications, and the like, to the time combinations meeting the user's needs are displayed as options according to an embodiment of the present invention.

FIG. 6 is a schematic diagram illustrating the operations performed by a configuration program when each category contains one registered net market according to an embodiment of the present invention.

FIG. 7 is a schematic diagram illustrating the operations performed by a configuration program when categories contain more than one registered net market according to an embodiment of the present invention.

FIG. 8 is a flowchart illustrating the operations performed by a configuration program when each category contains one registered net market according to an embodiment of the present invention.

FIG. 9 is a flowchart illustrating the operations performed by a configuration program when categories contain more than one registered net market according to an embodiment of the present invention.

### DETAILED DESCRIPTION OF THE INVENTION

Embodiments of the present invention are directed to improvements of the conventional electronic commerce model established to provide configurations from a single, independent service site. Multiple related net markets are logically linked in an organic manner to provide configurations that, based on restriction conditions or the like, combine fixed data, such as electronic catalogs, provided by these net markets. In formats such as auctions and negotiations, the present invention does not require generating rules that take user and system restrictions into account, a process that was difficult to implement in the conventional technology. Instead, as long as product specification information is available, the providers participating in net markets will be responsible for providing products that meet restrictions, thus allowing configurations to be generated.

Two examples that implement this method are described below. In the first example, “product-service combinations” will be presented in a system that responds to user requests by combining net markets for electronic devices and computers, net markets for shipping, net markets for insurance, and net markets for payment. In the second example, “service-service combinations” will be presented in a system that responds to user requests by combining net markets for airline tickets, net markets for hotels, net markets for trains, net markets for buses, net markets for restaurants, and net markets for entertainment. These examples are merely illustrative and do not limit the invention. One of ordinary skill in the art would recognize other variations, modifications, and alternatives.

Managing and controlling these groups of net markets requires a service site (i.e., an electronic store system according to the present invention, hereinafter “a configuration portal site”). Based on conditions input by users, this configuration portal site looks up various management tables at the site, generates the necessary programs (to extract relevant net markets, combine these markets, generate net market navigation routes, travel along these routes, and issue offers), and manages/controls execution status for these programs. The user accesses this configuration portal site and enters the information needed to meet the user's needs so that product options that meet these needs can be retrieved.

Logically, these net markets are linked in an organic manner, but physically the net markets are all linked via the configuration portal site. This configuration portal site is equipped with protocol conversion/format conversion functions that allow communication with these net markets.

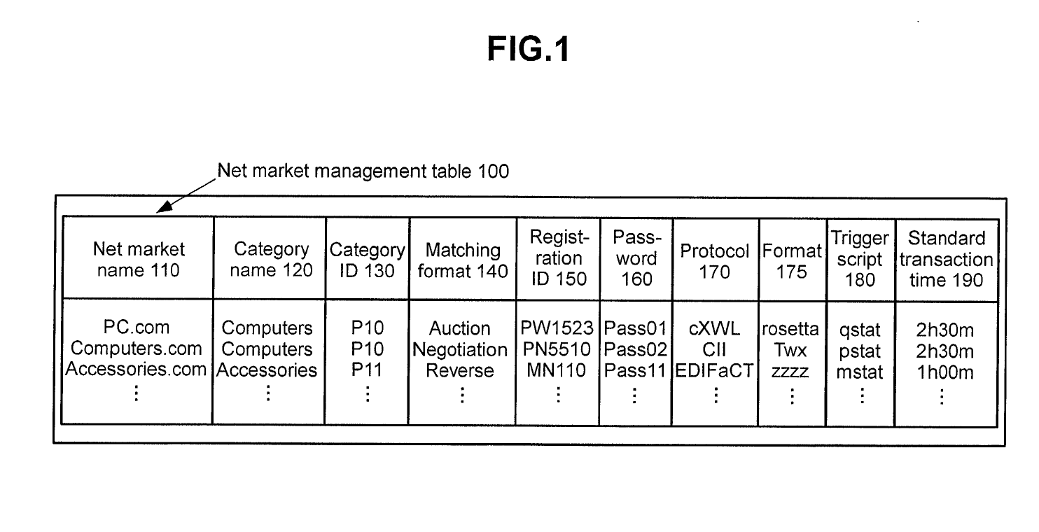

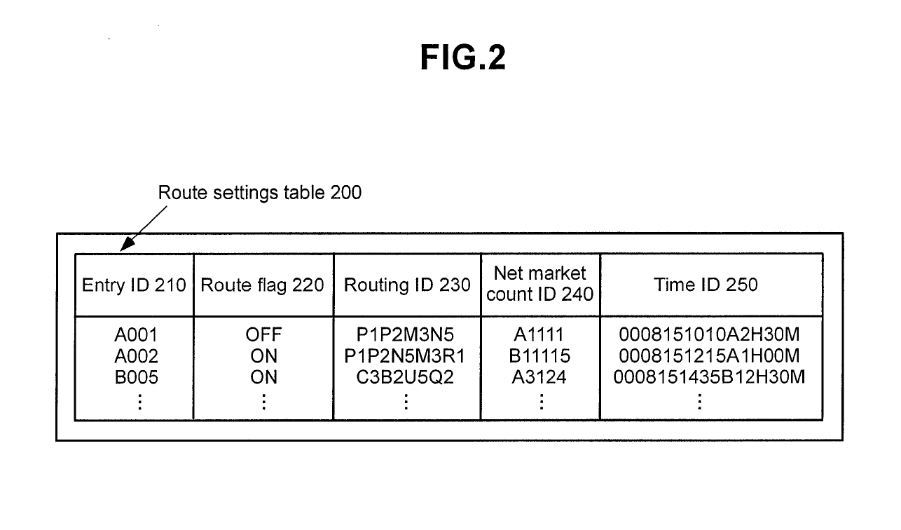

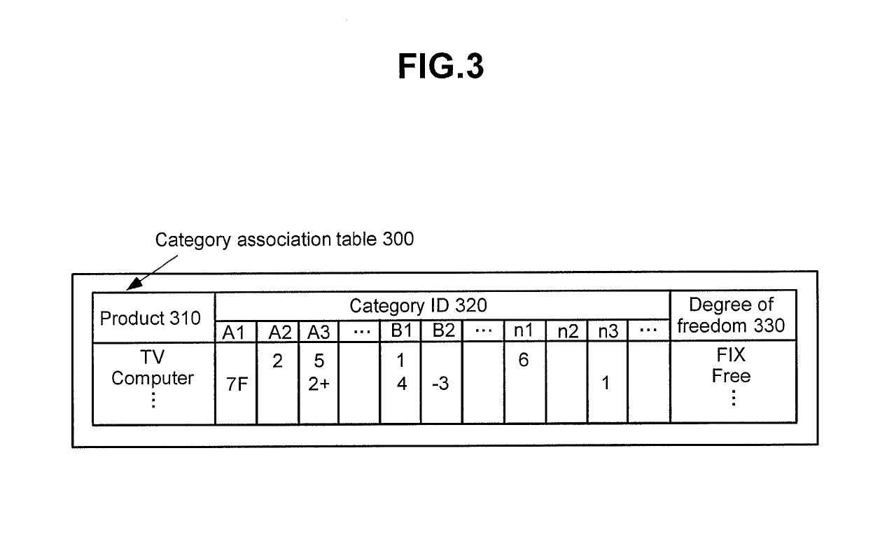

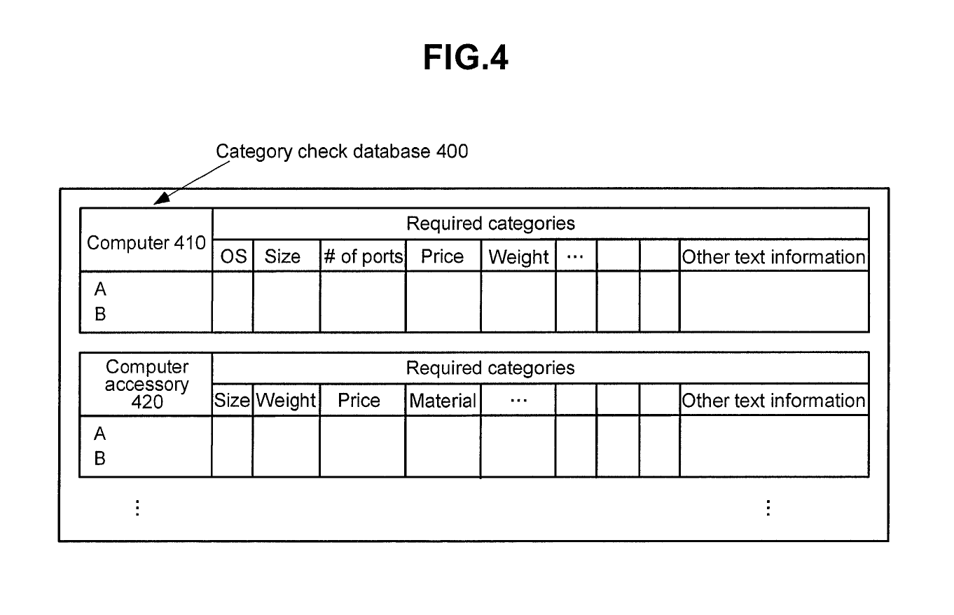

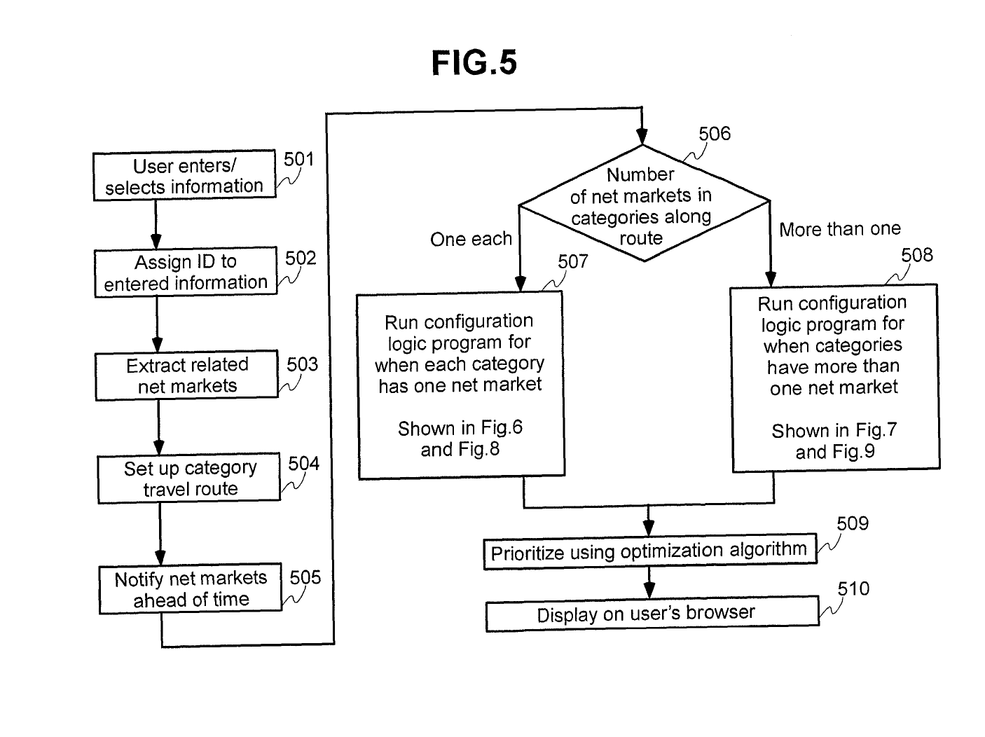

Specific embodiments of the present invention are described in detail with reference to the attached drawings. Briefly, FIG. 1 shows a data structure for a net market management table which manages detailed information concerning registered net markets. A data structure for a route settings table is illustrated in FIG. 2. FIG. 3 shows a data structure for a category association table, which manages associations between products and the parts/service category associated with the product. The category association table also manages rules for travel routes (i.e., category traveling sequences). The route settings table of FIG. 2 is used to manage the generated net market travel routes. FIG. 4 shows a structure for a category check database, which is provided for the entry of detailed information about and categories of products supplied by a provider submitting offers meeting user conditions. In FIGS. 5-9, various flow charts and diagrams are used to illustrate the operations performed by a configuration program employing the data structures of FIGS. 1-4.

FIG. 1 shows a data structure for a net market management table. Net market 100 manages detailed information about registered net markets. Net market name 110 is the name of a net market. Category name 120 is the name of a category associated with the product/service provided by a net market. Category ID 130 is an ID for categories that was assigned ahead of time. Matching format 140 is information about the auction/reverse auction/negotiation format to be used when net markets match up user needs with the products offered by the provider. Registration ID 150 is a user ID issued when the electronic store system according to the present invention (hereinafter “the present system”) logs in to a net market. Password 160 is issued when the present system logs into a net market. Protocol 170 is a protocol name, e.g., XML, that is used as a standard by a net market. Format 175 is a name of the format used as a standard by a net market when sharing information such as product specifications. Trigger script 180 is the name of a script that kicks in an activation program that initiates transactions with registered net markets. Standard transaction time 190 is a standard transaction time for individual net markets (actually for individual categories).

The data in net market management table 100 is registered ahead of time. The table is updated; for example, when a new net market begins participating or when an existing net market stops doing business or changes its name.

FIG. 2 shows a data structure for a route settings table. Route settings table 200 is used to manage generated net market travel routes. Entry ID 210 is an entry management ID assigned to individual products when a user enters various information. Route flag 220 indicates whether one or multiple routes were generated. Multiple routes are indicated if the flag is set (the flag is ON). Routing ID 230 is generated by sequentially combining the category IDs in a route. Routing ID 230 takes the route determined on the basis of the user's needs, retrieves category information, converts these to IDs, and enters these IDs into the route settings table. Net market count ID 240 combines the number of net markets in a category, sequentially, in the order of the travel routes. The number of net markets in a category is derived from net market management table 100. Time ID 250 indicates the transaction period (in hours and minutes) of the categories in a route. This is calculated from the user's desired shipping date and the route.

FIG. 3 shows a data structure for a category association table. Category association table 300 manages associations (links) between products and the parts/service category associated with the product. Rules for travel routes (category traveling sequences) are also managed. Product name 310 is a name of a product requested for purchase by a user. Category ID 320 represents a collection of category IDs 130 set up ahead of time. Each category has an assigned value that indicates where the category should be positioned in a standard travel route associated with a particular product. If an entry indicates a fixed value (e.g., a particular category must always be last), an “F” is added to the value. If a category must always be immediately followed by a specific category, a “+” is added to the end of the value and a “−” is added at the beginning of the entry for the category that must follow. For example, the sequence value in category ID 320 “A3” for computers is “2+”, and the sequence value in the category ID 320 “B2” is “−3”. This indicates that B2 must always come immediately after A3. Flexibility or degree of freedom 330 is a flag indicating whether the standard route can be freely varied. “FIX” indicates that the route cannot be changed, and “Free” indicates that it can be.

FIG. 4 shows a structure for a category check database. Category check database 400 is provided for the entry of detailed information about and categories of products supplied by a provider submitting offers meeting user conditions. In the case of computers, a computer 410 table will contain, for the operating system, “Windows 95” (a registered trademark of Microsoft), “Windows 98” (a registered trademark of Microsoft), or “MacOS” (a registered trademark of Apple). Other entries include size, number of ports, price and weight. If travel is the category, a hotel can enter information such as the name of the closest station or airport, the distance from that location, price, meals, and remodeling dates. These categories are determined ahead of time by the operator providing services at the configuration site. The providers offering products are the ones who actually enter information for these categories.

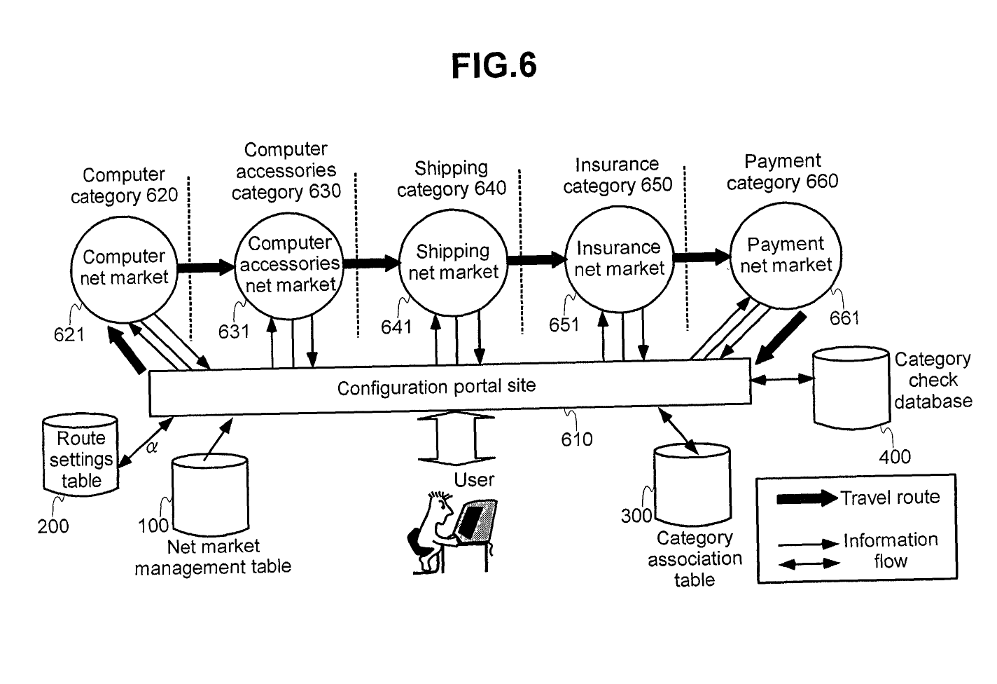

FIG. 5 is a flowchart indicating the operations performed when a user accesses the configuration portal, enters required information such as specifications, and the combinations that meet these needs are displayed as options. At step 501, the user accesses a configuration portal 610 shown in FIG. 6. The user enters/selects information (name of product desired for purchase and conditions desired by the user).

At step 502, for each product, an entry management ID is assigned to information such as the entered/selected product name; the services and specifications that make up the product; whether the product involves insurance, local delivery, or added services such as restaurant guides or entertainment guides; desired purchase price; shipping date; important factors (e.g., price is more important than shipping date); desired routes in the case of travel. The entry management ID is stored in entry ID 210 of route settings table 200.

At step 503, the entered information is used as a basis for looking up the information in net market management table 100 and extracting net markets that provide the corresponding services. Category association table 300 manages the linkages between net markets providing categories (parts or services) which make up a product. For example, if an electronic device is to be purchased and the user selects “buy computer,” the computer, shipping, insurance, and payment categories are linked. Inexpensive computer peripherals do not require insurance. If the user is an individual, certain payment processes are not required. For computers, PC accessory categories can be selected, as desired, to purchase screens large enough to ease eye strain. The configuration site can be equipped with functions to check combinations (functions to check operating systems and, for example, the number of ports used to connect peripherals such as USB ports). In addition, net markets providing software can be selected. If the user selects “buy TV,” TV, TV accessory (e.g., offering TV stands), and shipping categories are linked. Only these linked categories are shown on the user's browser. From these, the user can select options such as “high performance,” “inexpensive,” or “shipping date is more important than price”. For travel arrangements, selecting “overseas travel with visits to multiple cities” results in the linked categories of airline tickets, hotels, domestic transportation tickets (bus, train, taxis), restaurants, entertainment, and insurance. From these, the user can select requests such as “no buses,” “prefer train for domestic transportation,” “use taxis for short distances,” and “no need for restaurants or entertainment.” If “local domestic travel” is selected, there is, of course, no need for airline ticket net markets.

At step 504, a sequence in which to traverse the extracted categories is determined by generating a travel route based on the information in the category association table 300, which indicates user-selected prioritizations and net market linkages. The travel route is similar to the route a regular customer would use to visit individual specialized stores in a certain order. In generating the route, the flexibility 330 flag is checked and the standard route is used if the flag is set to “FIX”. If the flag is set to “Free”, the route is set up starting with the categories having higher priorities for the user while taking into account the restrictions added to the numeric values.

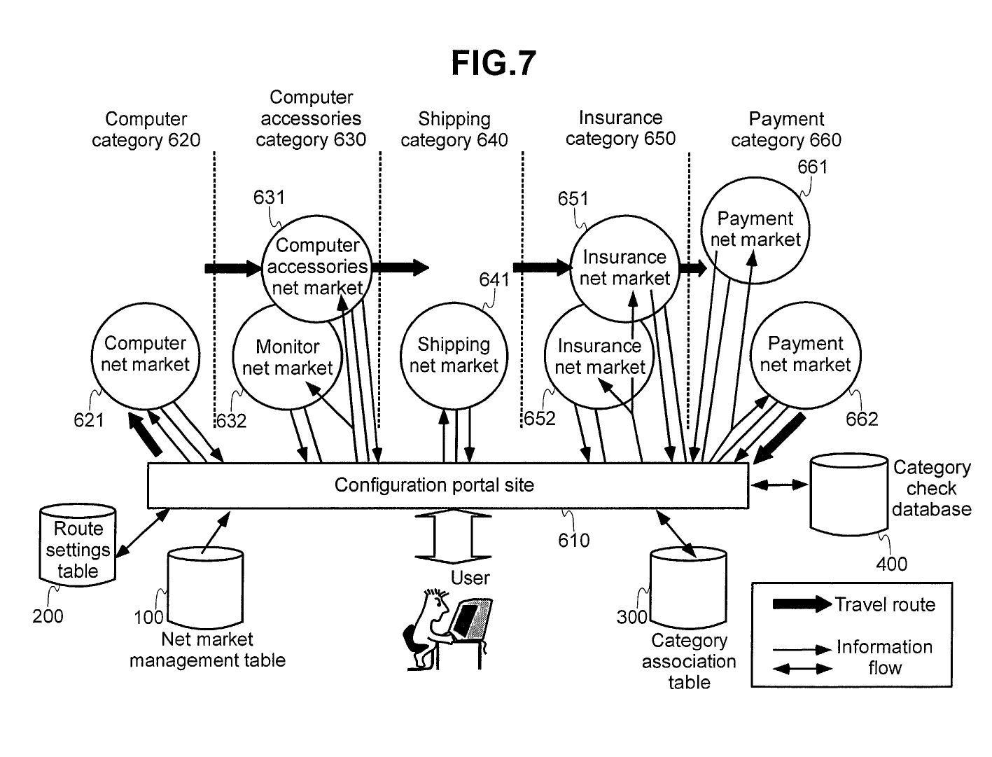

In the specific examples shown in FIGS. 6 and 7, a route is set up as follows: computer category 620—PC accessories category 630—shipping category 640 insurance category 650—payment category 660. In the case of overseas travel, the route is set up as follows: airline ticket category—hotel category—restaurant and entertainment category—domestic transportation category—insurance category.

The sequence set up in this manner is registered in routing ID 230 of route settings table 200. If there are multiple net markets registered for a category, route flag 220 in route settings table 200 is set to indicate that there are multiple routes, and the number of net markets in each travel route is recorded in net market count ID 240.

At the same time, the time category for each net market is set up based on the transaction period information entered by the user, the characteristics of the extracted net markets, and the number of categories and routes. More specifically, a standard transaction time is determined for each category based on the standard lead time for products/services. This is stored in standard transaction time 190. The portion of time for each category in the total standard transaction time for the selected categories is assigned to the user-requested transaction lead time and calculated. Time ID 250 allows easy calculation of the time for starting and ending auction and negotiation transactions at net markets.

At step 505, these results, information entered/selected by the user, and guidelines indicating detailed categories of information to be furnished by the provider are sent to net markets before buying or selling takes place. At the net market, this information is posted on a bulletin board so that firms participating in auctions or negotiations can prepare adequately for the transaction, thus providing improved transactions. In addition, the ending time for the transaction activation program in the net market is set.

At step 506, route flag 220 of route settings table 200 is looked up and the number of routes that were set up is determined. Depending on whether the route count is one or more than one, different programs (hereinafter “configuration programs”) will be used to perform specific configuration operations while traveling to the different net markets.

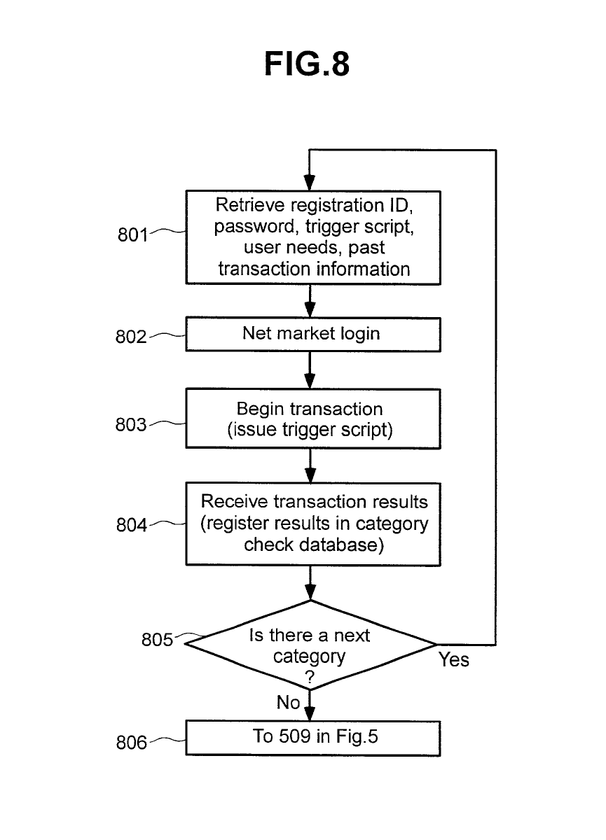

Step 507 runs the configuration program for the situation where each category has only one registered net market. FIGS. 6 and 8 show specific examples.

FIG. 6 illustrates the operations performed by the configuration program if each category has one registered net market. FIG. 8 is a flowchart showing the operations performed by the configuration program if each category has one registered net market.

For example, a user may want to buy a computer, and a computer net market 621 is the first net market in the route to perform a transaction.

A user ID and password registered ahead of time in the registration ID 150 and password ID 160 fields in net market management table 100 are retrieved and issued by configuration portal site 610 (step 801). Access is established to computer net market 621 (step 802). Trigger script 180 is retrieved and issued to initiate the auction or negotiation transaction (step 803). Based on the information about the user's needs, a product provider sends computer net market 621 detailed information about products offered, their prices, and shipping dates. The provider must enter information about individual categories in the input areas for storage in category check database 400. If information is missing from the input area, the information will not be passed on to the next category. The transaction ending time is based on the total transaction time set up beforehand. Using the input information pertaining to the user's needs, computer net market 621 sends configuration portal site 610 information about products that meet the user's needs to a high degree (step 804).

If there are multiple products meeting the user's needs, information about the multiple products is sent. The product information is also provided when the provider makes the sale of the product.

Configuration/portal site 610 receives the search results from step 804 and, at step 805, issues a user ID and password, as described above, to the net market (in this case a computer accessories net market 631) that is set up as the next stop in the route. The product information selected by the computer net market 621 is sent and a trigger script 180 that triggers sales is issued along with information about the desired product conditions or criteria entered by the user.

Then, as described above, a transaction is begun at computer accessories net market 631, and the product provider sends computer accessories net market 631 detailed information about the products it can offer, their prices, and shipping dates, based on retrieved product information. If the product provider does not enter information in the input area, the information is invalid. The end of the transaction is determined by the time set up beforehand. Checking of the contents and the requirements relating to shipping dates provided by the provider are the responsibilities of the accessory provider. However, in practice, detailed specifications for products are displayed on the user's browser so that obvious mistakes (e.g., a screen that is too small for a monitor) are eliminated when the user decides on the purchase. Computer accessory net market 631 sends product information indicating the search results and possible product combinations to configuration portal site 610.

Then operations similar to those performed by the program for computer accessory net market 631 are performed all the way to the end of the defined route. In this case, operations are performed until configuration portal site 610 receives search results from the payment net market 661.

Referring back to FIG. 5, the operations at step 508 for cases where multiple net markets belong to a category in the defined route, will be described.

If multiple net markets belong to a category in the defined route, configuration portal site 610 first looks up route settings table 200 upon receipt of transaction results information from the previous net market. Then, to access the net markets of the current category, configuration portal site 610 retrieves the registration ID 150, the password 160, and the transcript 180 for each of the extracted net markets so that they can be sent out together when accessing a net market. This is defined as the initialization operation.

When the transaction results information from the first net market in the category are obtained, net market count ID 240 in route settings table 200 is looked up to determine the number of sets of information to be received. This is defined as the closing operation. Then, once receipt of all information is confirmed, the initialization operation defined above is repeated.

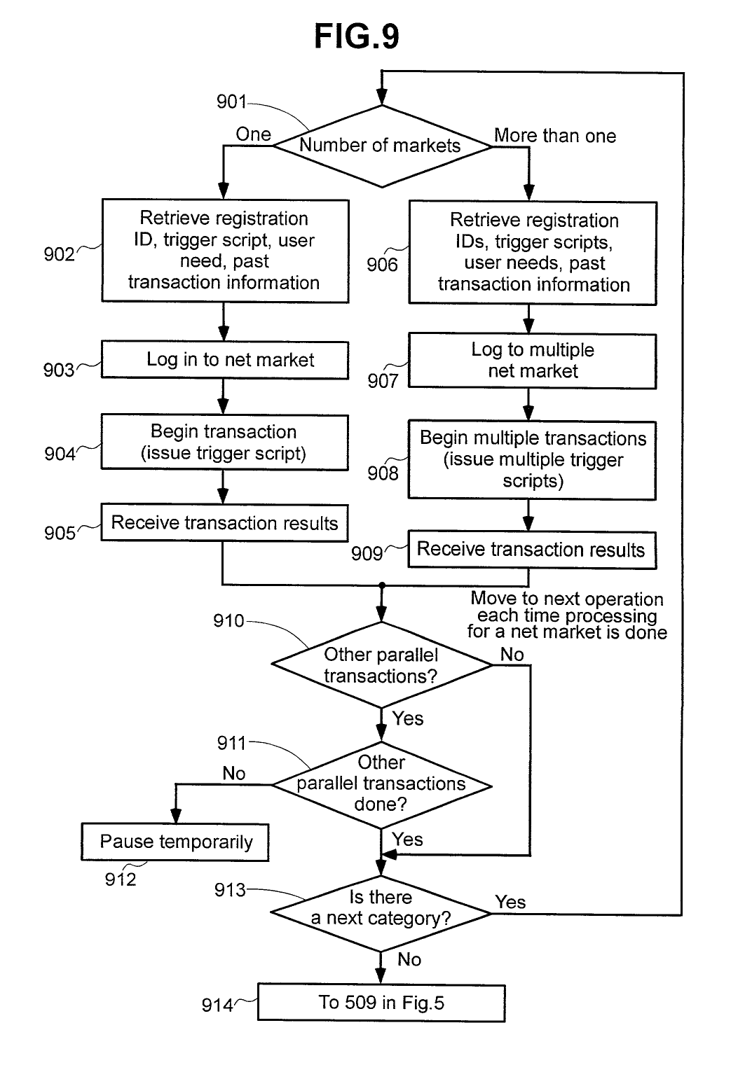

A specific example is described using FIGS. 7 and 9.

FIG. 7 is a schematic drawing of the operations of the configuration program when there are multiple net markets registered in a certain category. In this case, there are two net markets in each of the computer accessories category 630, the insurance category 650, and the payment category 660.

FIG. 9 is a flowchart of the operations of the configuration program if there are multiple net markets registered in a certain category.

The number of markets coming up next is determined at step 901 in FIG. 9. If the market count is one, the operations at steps 902-905 are performed. The operations performed at steps 902-905 are similar to those performed at steps 801-804 in FIG. 8. If there is more than one market, the operations at steps 906-909 are performed. At step 906-step 909, the operations similar to step 801-804 in FIG. 8 are performed for each of the multiple net markets. Each time processing for a net market is completed (i.e., each time transaction results are received), the operations beginning with step 910 are performed. At step 910, the existence of other transactions being performed in parallel is checked. If other parallel transactions have not been completed, the operation is temporarily stopped (step 912). If there are no other parallel transactions or if the parallel transactions have all been completed, step 913 checks to see if there is a subsequent category. If so, the operations starting at step 901 are repeated.

As shown in FIG. 7, there is only one net market in computer category 620 that is accessed first. At steps 902-905 in FIG. 9, operations similar to those described with reference to FIGS. 6 and 8 are performed for computer net market 621.

After receiving transaction results information at step 905, configuration portal site 610 accesses route settings table 200 at step 910 and checks the number of net markets set up for the previous category (in this case, computer category 620). Since one set of information is received from computer category 620, operations for the next category are performed at step 913. As shown in FIG. 7, computer accessory category 630 contains computer accessory net market 631 and a monitor net market 632. Configuration portal site 610 accesses net market management table 100, retrieves and issues user IDs and passwords for two net markets, and accesses the two net markets (steps 906, 907). When logins are confirmed, the product information retrieved from the previous category, i.e., computer category 620, is passed on to the respective net markets and two associated trigger scripts from trigger script 180 are retrieved and issued (step 908). Transactions performed with the net markets are similar to those in the example from FIG. 6.

Computer net market 631 and monitor net market 632 send their respective search results and product information indicating possible product combinations to configuration portal site 610. First, configuration portal site 610 receives one set of transaction information results at step 909. Then, at step 910, net market count ID 240 in route settings table 200 is looked up and the existence of other parallel transactions is checked. In this case, it is determined that two sets of transaction information results are to be received. Processing does not take place until two sets of transaction results information are received (steps 911, 912). At step 913, upon receipt of two sets of transaction results information, route settings table 200 and net market management table 100 are looked up, and the number of net markets in the next category, in this case shipping net market 641, and the net market name are determined (step 913, 901). The series of operations such as issuing a user ID and password, passing on product information, and issuing a trigger script are performed for shipping net market 641 (steps 902-905).

In this manner, the operations shown in FIG. 9 are performed until the end of the defined route is reached. In this example, after configuration portal site 610 receives transaction information results from both insurance net market 651 and insurance net market 652, payment net market 661 and payment net market 662 are accessed, and operations are performed until the transaction information results from these net markets are received by the configuration portal site 610.

Once the entire travel route is completed, the product combinations that have been obtained are prioritized at step 509 from FIG. 5. In an example of how a prioritization algorithm is composed, the user request may be “the highest performance product under xxxx yen that can be delivered in two days”. In this case, combination groups are weighted for the categories “price”, “performance”, and “delivery date” so that the weighting totals 10 (e.g., price:performance:delivery date=4:4:3).

At step 510, the combination information is displayed on the user's browser along with detailed information about the products and services.

In this embodiment, module for providing product information, module for extracting net markets, and module for setting up routes are provided through the execution of programs (software) at configuration portal site 610. Similarly, module for assigning an ID to user input information and registering the ID in a route settings table; module for looking up the net market management table and extracting net markets related to the user input information; module for looking up the category association table and setting up a travel route for a purchase; module for registering the travel route information in the route settings table; module for transacting with net markets based on travel routes; module for prioritizing product combinations supplied by net markets based on user input information; and module for supplying purchase candidate product information supplied by the net markets and user input information to the next net market, based on the travel route, are all provided through the execution of programs (software) at configuration portal site 610. The electronic store system according to specific embodiments of the present invention can be implemented as configuration portal site 610 equipped with a computer server system. Configuration portal site 610, the user, and the net markets 621, 631, 632, 641, 651, 652, 661, and 662 may be connected via an open network such as the Internet.

Some of the specific advantages of the present invention include the ability to easily provide optimum combinations and to allow products with specifications meeting the user's interests, the ability to also purchase accessory services such as shipping, insurance, and payment services, the ability to make a purchase of a product or multiple products at one location without the requirement of multiple logins, and the elimination of the need for the user to perform tedious product searches since the basic product information is passed on from net market to net market.

As a result, concessions that a user has to make when purchasing products over the Internet can be minimized while significantly improving the convenience of Internet transactions. In addition, a provider of services or products, can increase business opportunities without the need to invest in a large number of channels. Furthermore, surplus inventory that significantly limits profits can be eliminated.

With conventional net market businesses and Internet transaction businesses, a major factor in competition (besides improving customer service through large investments) has been in product options and ease of use, areas in which differentiation can be difficult. As a result, profitability is made harder due to the scale of investments needed and the high levels of competition.

Because of these factors, for businesses that provide services over the Internet, the present invention can create large market opportunities while being a significant differentiating element from the competition.

The preferred embodiment of the present invention having been described in detail, persons skilled in the art will appreciate that modifications and variations of the present invention can be made without departing from the spirit or scope of the invention as defined by the claims.

What is claimed is:

1. A system for providing products to a user in a network environment, the system comprising:
an information entry module configured to receive user input information from a user relating to selection of a plurality of products, each product having one or more associated net markets which are arranged into categories for each of the plurality of products;
a route setting module configured to set up travel routes through the categories containing the net markets associated with the plurality of products which are received by the information entry module; and
an information receiving module configured to receive product information of the plurality of products from the net markets associated with the products along a travel route set up by the route setting module.

2. A system as recited in claim 1 further comprising a category association database storing rules for linking the net markets associated with the plurality of products.

3. A system as recited in claim 2 wherein the information entry module presents to the user, products linked by the category association database according to the rules for linking the net markets associated with the plurality of products, in response to the user input information received from the user relating to the selection of the plurality of products.

4. A system as recited in claim 2 wherein the route setting module sets up travel routes through the categories containing the net markets associated with the plurality of products according to the rules for linking the net markets stored in the category association database.

5. A system as recited in claim 1 further comprising a net market extraction module configured to access net market information of net markets from a net market management database and extract the net markets associated with the plurality of products based on the information received from the user relating to the selection of the plurality of products.

6. A system as recited in claim 5 further comprising a net market registration module configured to register a net market in the net market management database when a request for participation is received from the net market.

7. A system as recited in claim 1 wherein the information receiving module receives, along the route set up by the route setting module, product information in each category for products that can be combined to form one or more sets of products, based on candidate product information received in a previous category along the route.

8. A system as recited in claim 1 further comprising a prioritization module configured, when the product information received by the information receiving module covers a plurality of sets of products supplied by the net markets, to prioritize the sets of products according to an order of priority based on the user input information received from the user relating to the selection of the plurality of products.

9. A system as recited in claim 8 further comprising an output module configured to output to the user the sets of products in the order of priority.

10. A system as recited in claim 1 further comprising a transaction module configured to transact with the net markets along the travel routes.

11. A method for providing products to a user in a network environment, the method comprising:
receiving from a user entry of information relating to selection of a plurality of products, each product having one or more associated net markets which are arranged into categories for each of the plurality of products;
extracting from a net market management database, which contain net market information of net markets, the net markets associated with the plurality of products based on the information received from the user relating to selection of the plurality of products;
setting up one or more travel routes through the categories containing the net markets associated with the plurality of products; and
performing transactions with the net markets along the one or more travel routes.

12. A method as recited in claim 11 wherein the one or more travel routes are set up through the categories according to rules for linking the net markets associated with the plurality of products, in response to the information received from the user relating to the selection of the plurality of products.

13. A method as recited in claim 12 wherein the rules for linking the net markets are stored in a category association database.

14. A method as recited in claim 11 further comprising, when the transactions with the net markets produce a plurality of sets of products supplied by the net markets, prioritizing the sets of products according to an order of priority based on the information received from the user relating to the selection of the plurality of products.

15. A method as recited in claim 14 further comprising providing to the user product information received from the net markets for the sets of products in the order of priority.

16. A computer program product stored on a computer readable medium for providing products to a user in a network environment, the computer program product comprising:
code for receiving from a user entry of information relating to selection of a plurality of products, each product having one or more associated net markets which are arranged into categories for each of the plurality of products;
code for extracting from a net market management database, which contain net market information of net markets, the net markets associated with the plurality of products based on the information received from the user relating to selection of the plurality of products;
code for setting up one or more travel routes through the categories containing the net markets associated with the plurality of products; and
code for performing transactions with the net markets along the one or more travel routes.

17. A computer program product as recited in claim 16 further comprising, when the transactions with the net markets produce a plurality of sets of products supplied by the net markets, code for prioritizing the sets of products according to an order of priority based on the information received from the user relating to the selection of the plurality of products.

18. A computer program product as recited in claim 17 further comprising code for providing to the user product information received from the net markets for the sets of products in the order of priority.

19. A memory for storing data for access by an application program being executed in a data processing system, comprising:
a first data structure stored in the memory, the first data structure used by the application program and comprising net market information of a plurality of net markets including net markets which are associated with a plurality of products selected in response to user input information provided by a user relating to selection of the plurality of products; and
a second data structure stored in the memory, the second data structure used by the application program and comprising rules for linking the net markets associated with the plurality of products selected in response to the user input information provided by the user relating to the selection of the plurality of products, the associated net markets being arranged into categories for each of the plurality of products, the rules for linking net markets to be used for setting up net market travels routes through the categories.

20. A memory as recited in claim 19 further comprising a third data structure stored in the memory, the third data structure used by the application program and comprising net market travel routes generated based on the rules for linking net markets, in response to the user input information provided by the user relating to the selection of the plurality of products.
